(19) United States
(12) Patent Application Publication
(10) Pub. No.: US 2019/0173772 A1
(43) Pub. Date: Jun. 6, 2019

(54) METHOD OF MONITORING, INFORMATION PROCESSING APPARATUS, AND COMMUNICATION APPARATUS

(71) Applicant: FUJITSU LIMITED, Kawasaki-shi (JP)

(72) Inventors: Tatsuya Hamachi, Nakagawa (JP); Kenichi Ohyama, Fukuoka (JP); Yushi Nobayashi, Fukuoka (JP)

(73) Assignee: FUJITSU LIMITED, Kawasaki-shi (JP)

(21) Appl. No.: 16/202,845

(22) Filed: Nov. 28, 2018

(30) Foreign Application Priority Data
Dec. 4, 2017 (JP) 2017-232456

(51) Int. Cl. H04L 12/26; H04L 12/24; H04L 29/06

(52) U.S. Cl. CPC H04L 43/10; H04L 69/28; H04L 41/069; H04L 43/067

(57) ABSTRACT

A method of monitoring includes transmitting, by a computer, a polling signal to a first communication apparatus, receiving, from the first communication apparatus, information on a first notification target which is detected in the first communication apparatus and first interval information indicative of a difference between timing at which the first notification item is detected and timing at which the polling signal is received in the first communication apparatus, and determining, based on first time information indicative of timing at which polling is performed and the first interval information, a time sequence of the first notification target and a second notification target which is detected in a second communication apparatus.

### CROSS-REFERENCE TO RELATED APPLICATION

This application is based upon and claims the benefit of priority of the prior Japanese Patent Application No. 2017-232456, filed on Dec. 4, 2017, the entire contents of which are incorporated herein by reference.

### FIELD

The embodiment discussed herein relates to a method of monitoring, an information processing apparatus, and a communication apparatus.

### BACKGROUND

As information processing technologies and communication technologies develop in recent years, sophistication of maintenance and operation of systems is demanded.

Related art is disclosed in Japanese Laid-open Patent Publication No. 2009-296320 or 2013-168852.

### SUMMARY

According to an aspect of the embodiments, a method of monitoring includes: transmitting, by a computer, a polling signal to a first communication apparatus; receiving, from the first communication apparatus, information on a first notification target which is detected in the first communication apparatus and first interval information indicative of a difference between timing at which the first notification item is detected and timing at which the polling signal is received in the first communication apparatus; and determining, based on first time information indicative of timing at which polling is performed and the first interval information, a time sequence of the first notification target and a second notification target which is detected in a second communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a monitoring system;

FIG. 2 illustrates an example of a hardware configuration of a communication apparatus;

FIG. 3 illustrates an example of processing when a state change of the communication apparatus is detected;

FIG. 4 illustrates an example of processing when the communication apparatus receives a polling signal;

FIG. 5 illustrates an example of a hardware configuration of a monitoring apparatus;

FIG. 6 illustrates an example of a response data table;

FIG. 7 illustrates an example of an occurrence sequence table;

FIG. 8 illustrates an example of processing when the monitoring apparatus performs the polling;

FIG. 9 illustrates an example of a response data table; and

FIG. 10 illustrates an example of an occurrence sequence table.

### DESCRIPTION OF EMBODIMENTS

For example, a monitoring apparatus performs polling on each of devices of a monitoring target in a system so as to collect information on processing history and problem history of each of the devices. The monitoring apparatus controls the collected information as historical information in the order of the processing or in the order of the occurrences of the problems.

For example, the monitoring apparatus performs polling sequentially at a fixed period. This causes, for example, when abnormalities occur in the devices of the monitoring target, the monitoring apparatus to incorrectly control a sequence in time of the occurrences of the abnormalities in each of the devices depending on timing of the polling from the monitoring apparatus to the devices when abnormalities occur in a plurality of the devices.

For example, a technique that improves accuracy of a time sequence of the occurrences relating to the collected information may be provided.

Each processing according to an embodiment may be appropriately varied. In principle, the same reference signs denote the same elements throughout the drawings for description of the embodiment, thereby omitting redundant description thereof.

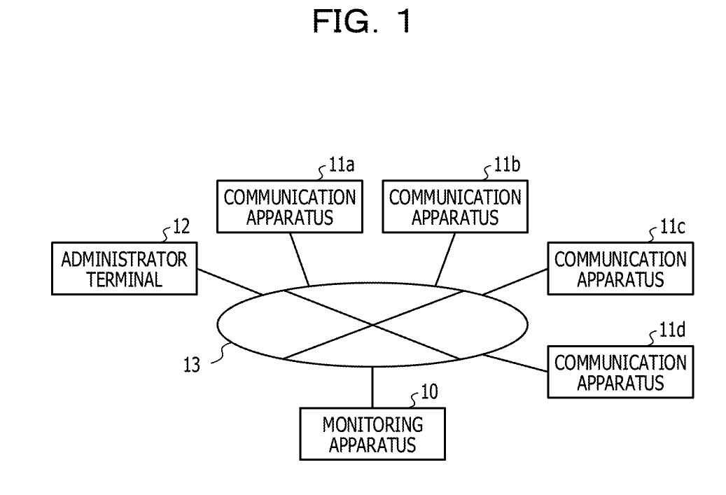

FIG. 1 illustrates an example of a configuration of a monitoring system. The monitoring system includes a monitoring apparatus 10, a communication apparatus 11a, communication apparatus 11b, a communication apparatus 11c, a communication apparatus 11d, and an administrator terminal 12. The monitoring apparatus 10, the communication apparatus 11a, the communication apparatus 11b, the communication apparatus 11c, the communication apparatus 11d, and the administrator terminal 12 are coupled to one another through a network 13.

Hereinafter, when the communication apparatus 11a, the communication apparatus 11b, the communication apparatus 11c, and the communication apparatus 11d are not distinguished from one another, these are referred to as “communication apparatuses 11”. Although four communication apparatuses 11 are illustrated in the example of FIG. 1, this is not limiting. The number of the communication apparatuses 11 may be four or more or four or less.

The monitoring apparatus 10 is, for example, a server apparatus that monitors states of the communication apparatuses 11 to be monitored coupled through the network 13. In order to check the states of each of the communication apparatuses 11 to be monitored, the monitoring apparatus 10 periodically performs polling so as to collect information such as processing history and problem history as notification target from the communication apparatuses 11. Through the network 13, the monitoring apparatus 10 sequentially transmits polling signals to each of the communication apparatuses 11 to be monitored and receives response signals from each of the communication apparatuses 11. The monitoring apparatus 10 stores information included in the response signals in a storage device.

The communication apparatuses 11 may be , for example, transmission devices such as routers or switching hubs. In response to reception of the polling signals, the communication apparatuses 11 transmit to the monitoring apparatus 10 the response signals in which information such as the processing history and the problem history as the notification target are included.

The administrator terminal 12 is, for example, a personal computer that includes a display. An administrator of the monitoring system views information collected in the monitoring apparatus 10 by using the administrator terminal 12.

The network 13 may be a network through which the communication apparatuses 11 transfer data through various types of processing or may be a network dedicated to the monitoring system.

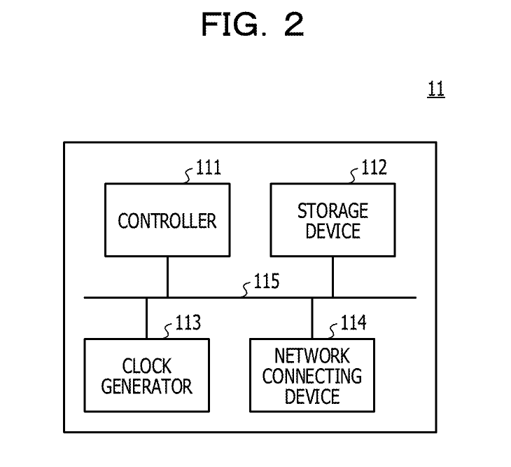

FIG. 2 illustrates an example of a hardware configuration of one of the communication apparatuses 11. The communication apparatus 11 includes a controller 111, a storage device 112, a clock generator 113, and a network connecting device 114. The controller 111, the storage device 112, the clock generator 113, and the network connecting device 114 are coupled to one another through a system bus 115.

The controller 111 is an apparatus which controls the communication apparatus 11. Electronic circuitry such as, for example, a central processing unit (CPU) or a micro-processing unit (MPU) may be used as the controller 111. Based on an operating system (OS) and various programs stored in the storage device 112, the controller 111 performs various types of processing by controlling operations of the communication apparatus 11 such as various computations and input/output of data to/from each of hardware structures. Various types of information and the like to be used during execution of the programs may be obtained from, for example, the storage device 112. Some of the types of processing to be performed by the controller 111 may be realized by using dedicated hardware. The controller 111 performs the processing according to the embodiment based on the programs according to the embodiment.

The storage device 112 stores, for example, the OS and application programs to be executed by the controller 111. The storage device 112 also stores the various programs and data used in the processing according to the embodiment to be performed by the controller 111. For example, a read-only memory (ROM), a random access memory (RAM), a flash memory, or the like may be used as the storage device 112.

The clock generator 113 may be, for example, oscillator circuitry that generates a clock signal at a fixed frequency in a range between 1 to 100 MHz. It is sufficient that the frequency of the clock signal generated by the clock generator 113 be higher than a frequency corresponding to the polling period of the monitoring apparatus 10. The frequency corresponding to the polling period is, for example, when the polling period is 100 msec, 10 Hz.

Based on, for example, a control signal from the controller 111, the network connecting device 114 transmits the response signal responding to the polling to the monitoring apparatus 10 coupled thereto through the network 13 as illustrated in FIG. 1.

Hereinafter, examples of operations of the communication apparatus 11 are described. Upon detecting a notification target such as an operating state or the occurrence of a problem as a state change of the communication apparatus 11, the controller 111 of the communication apparatus 11 starts counting clock cycles of the clock generator 113. Upon receiving a polling signal from the monitoring apparatus 10, the controller 111 determines a count value from the detection of the state change to the reception of the polling signal. The controller 111 transmits to the monitoring apparatus 10 the response signal responding to the polling in which information on the state change and the count value are also included.

Examples of the state change include, but are not limited to, a loss of light (LOL), a loss of signal (LOS), a client signal fail (CSF), a local fault (LF) and so forth.

Here, the count value is a count number of clock cycles from, for example, timing at which the state change is detected to timing at which the polling signal is received. Accordingly, the count value is information indicative of an interval from, for example, the occurrence of the problem to performing of the polling.

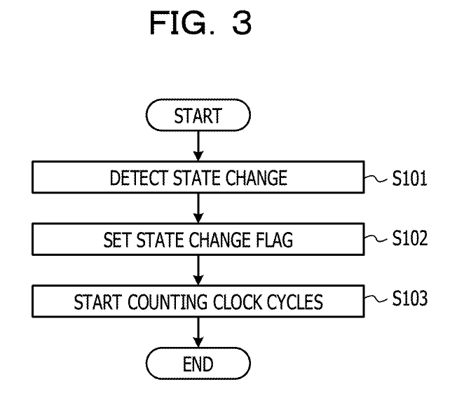

FIG. 3 illustrates an example of processing when the state change of the communication apparatus 11 is detected.

For example, the controller 111 of the communication apparatus 11 detects the state change of the communication apparatus 11 based on a monitor signal (S101). The controller 111 sets a state change flag indicative of the occurrence of the state change (S102). The controller 111 starts counting the clock cycles of the clock generator 113 (S103).

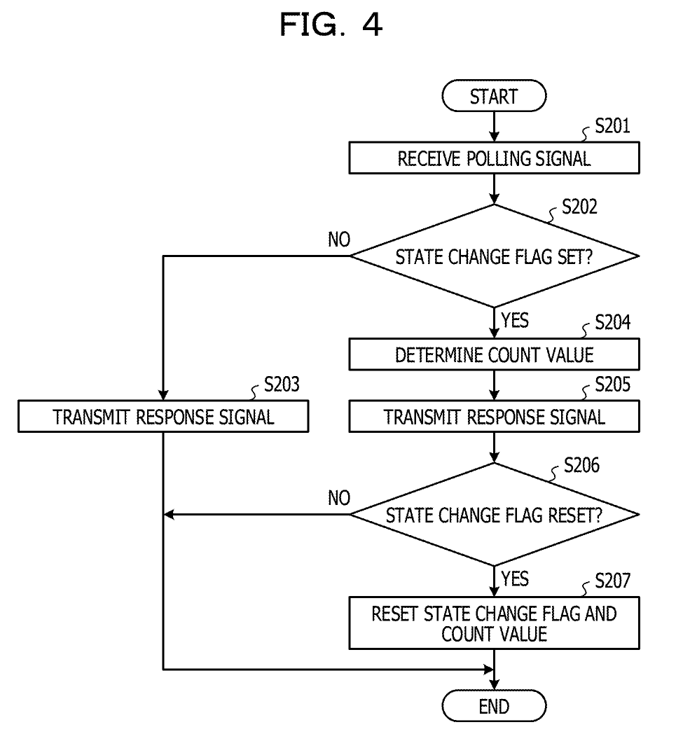

FIG. 4 illustrates an example of a procedure of processing when the communication apparatus 11 receives the polling signal.

For example, the communication apparatus 11 receives the polling signal transmitted from the monitoring apparatus 10 (S201). The controller 111 of the communication apparatus 11 determines whether the state change flag is set (S202).

When the state change flag is not set (No in S202), the controller 111 generates the response signal not including the information on the state change and transmits the generated response signal to the monitoring apparatus 10 (S203).

When the state change flag is set (Yes in S202), the controller 111 determines the count value of the clock cycles having been counted from the state change to the reception of the polling signal (S204). The controller 111 generates the response signal including the information on the state change and the determined count value and transmits the generated response signal to the monitoring apparatus 10 (S205).

The controller 111 determines whether to reset the state change flag based on the monitor signal (S206).

When it is determined that the state change flag is to be reset (Yes in S206), the controller 111 resets the state change flag and the count value to their initial states (S207).

When it is determined that the state change flag is not to be reset (No in S206), the controller 111 ends the processing without resetting the state change flag and the count value. When, for example, the state change is maintained after the transmission of the response signal, the controller 111 may determine not to reset the state change flag.

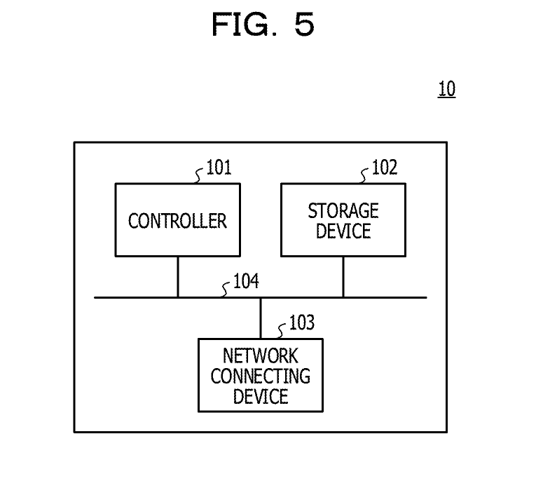

FIG. 5 illustrates an example of a hardware configuration of the monitoring apparatus 10. The monitoring apparatus 10 includes a controller 101, a storage device 102, and a network connecting device 103. The controller 101, the storage device 102, and the network connecting device 103 are coupled to one another through a system bus 104.

The controller 101 is a circuit that controls the monitoring apparatus 10. Electronic circuitry such as, for example, a CPU or an MPU may be used as the controller 101. Based on an OS and various programs stored in the storage device 102, the controller 101 performs various types of processing by controlling operations of the monitoring apparatus 10 such as various computations and input/output of data to/from each of hardware structures. The controller 101 executes, for example, a monitoring program so as to monitor a monitoring-target system. Various types of information to be used during the execution of the monitoring program may be obtained from, for example, the storage device 102. Some of the types of processing to be performed by the controller 101 may be realized by using dedicated hardware. The controller 101 performs the processing according to the embodiment based on the monitoring program according to the embodiment.

The storage device 102 may include a main storage device and an auxiliary storage device. For example, the main storage device temporarily stores at least some of the OS and application programs to be executed by the controller 101. The main storage device also stores various types of data to be used in the processing performed by the controller 101. For example, a ROM, a RAM or the like may be used as the main storage device.

The auxiliary storage device stores, for example, the monitoring program at least temporarily. The auxiliary storage device allows various types of information stored therein to be read or various types of information to be written thereto based on instructions from the controller 101. A storage or the like such as, for example, a hard disk drive (HDD) or a solid-state drive (SSD) may be used as the auxiliary storage device. The auxiliary storage device may store information to be used in the processing or results of the processing. The main storage device may function as part of or the entirety of the auxiliary storage device and the auxiliary storage device may function as part of or the entirety of the main storage device.

Based on, for example, a control signal from the controller 101, the network connecting device 103 transmits the polling signals to the communication apparatuses 11 coupled thereto through the network 13 as illustrated in FIG. 1.

In accordance with schedule information, the monitoring apparatus 10 periodically transmits the polling signals to the communication apparatuses 11 to be monitored. Upon receiving the response signal from one of the communication apparatuses 11, the monitoring apparatus 10 transmits the polling signal to the next communication apparatus 11. Here, the schedule information may be information which specifies the period at which the polling is performed or the order of the communication apparatuses 11 for performing the polling.

Upon receiving the response signal responding to the polling signal, the monitoring apparatus 10 determines, based on the count value included in the response signal and information on time at which the polling has been performed, a time sequence of the state change indicated by the information on the state change included in the response signal and the state change indicated by the information on the state change included in another response signal having already been received. Examples of the information on the time at which the polling is performed include, for example, information on time at which the polling signal is generated, information on time at which the polling signal is transmitted, information on time at which the response signal is received, and so forth. According to the present embodiment, the information on the time at which the polling signal is generated, the information on the time at which the polling signal is transmitted, and the information on the time at which the response signal is received may be regarded as substantially equivalent to one another.

The monitoring apparatus 10 may performed the determination processing as follows: extracting the information on the state change included in the response signal received responding to the polling performed on one of the communication apparatuses 11 between the previous and the present polling performed on the other communication apparatus 11; and determining the time sequence of the state change indicated by the extracted information on the state change and the state change indicated by the information on state change received responding to the present polling.

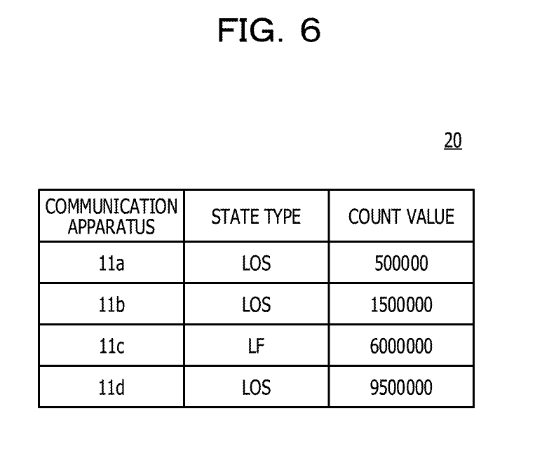

Here, an example of a method of determining the time sequence is described. It is assumed that the frequency of the clock of the communication apparatus 11 is 100 MHz. FIG. 6 illustrates an example of a response data table. The monitoring apparatus 10 causes the information included in the response signals received from the communication apparatuses 11 to be stored in a response data table 20 as illustrated in FIG. 6. Here, it is assumed that the time at which the polling has been performed on the communication apparatuses 11 is as follows: the polling has been performed on the communication apparatus 11b 25 msec after the polling had been performed on the communication apparatus 11a; the polling has been performed on the communication apparatus 11c 25 msec after the polling had been performed on the communication apparatus 11b; and the polling has been performed on the communication apparatus 11d 25 msec after the polling had been performed on the communication apparatus 11c.

The controller 101 of the monitoring apparatus 10 refers to the response data table 20, determines that the count value corresponding to the communication apparatus 11a is 500000, and obtains a calculation result that the occurrence of the state change in the communication apparatus 11a is 5 msec before the time at which the polling has been performed. Similarly, based on the count value, the controller 101 obtains calculation results that the occurrence of the state change in the communication apparatus 11b is 15 msec before the time at which the polling has been performed, the occurrence of the state change in the communication apparatus 11c is 60 msec before the time at which the polling has been performed, and the occurrence of the state change in the communication apparatus 11d is 95 msec before the time at which the polling has been performed.

Based on the numbers of seconds calculated based on the differences in time at which the polling for the communication apparatuses 11 has been performed and the count values of the communication apparatuses 11, the controller 101 of the monitoring apparatus 10 determines the time sequence such that, in the communication apparatuses 11, the state change occurs in the communication apparatus 11d, the communication apparatus 11c, the communication apparatus 11a, and the communication apparatus 11b in this sequence.

Based on the determined time sequence, the monitoring apparatus 10 causes the information on the state change to be stored in the storage device 102. Upon receiving a viewing request from the administrator terminal 12, the monitoring apparatus 10 may refer to the storage device 102 to output the historical information in which the information on the state change is arranged in the sequence of the occurrences.

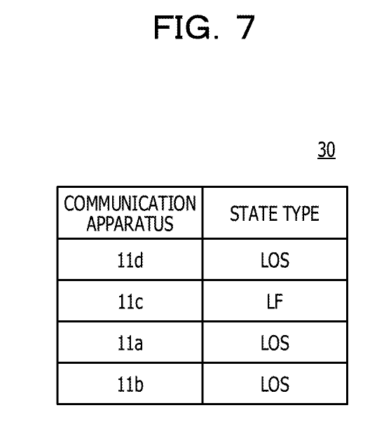

FIG. 7 illustrates an example of an occurrence sequence table. The monitoring apparatus 10 may store the state change information in an occurrence sequence table 30 as illustrated in FIG. 7 based on the determined time sequence. Pieces of the information on the state change are stored in the occurrence sequence table 30 from an upper record in a sequence from older to newer pieces of the information on the state change. The monitoring apparatus 10 may store in the storage device 102 pieces of information that allows the determined time sequence to be understandable by associating these pieces of information with the pieces of the information on the state change.

The monitoring apparatus 10 transmits the historical information including the information on the state change stored in the storage device 102 to the administrator terminal 12 in response to a viewing request from the administrator terminal 12.

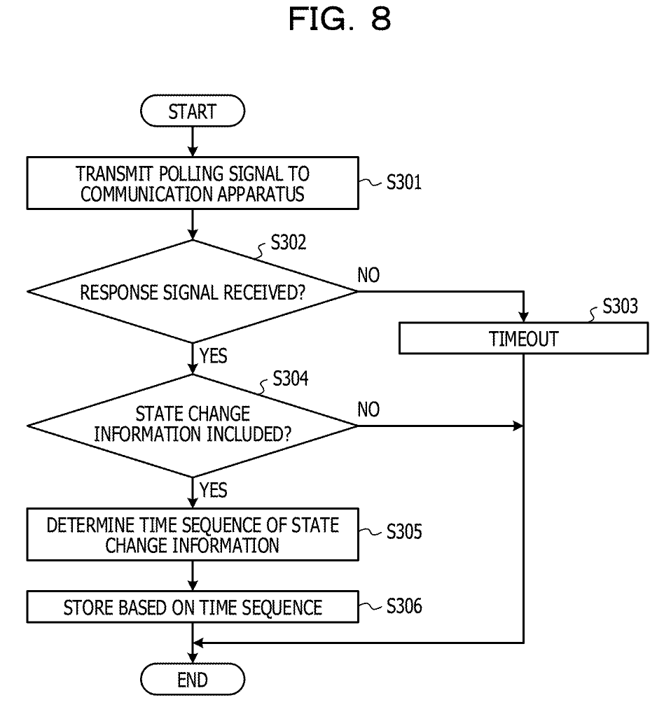

FIG. 8 illustrates an example of a procedure of processing when the monitoring apparatus 10 performs the polling.

For example, based on the schedule information on the polling, the controller 101 of the monitoring apparatus 10 generates the polling signal and transmits the polling signal to the communication apparatus 11 to be monitored (S301). The controller 101 determines whether the response signal from the communication apparatus 11 has been received (S302).

When the response signal has not been received within a specified time period from the transmission of the polling signal (No in S302), the controller 101 determines this state as a timeout, registers information indicative of abnormality relating to the communication apparatus 11, and ends the processing (S303). After the processing has proceeded to S303, the controller 101 may transition to the polling for the next communication apparatus 11.

When the response signal has been received (Yes in S302), the controller 101 determines whether the information on the state change is included in the response signal (S304).

When the information on the state change is not included (No in S304), the controller 101 ends the processing. After “No” in S304, the controller 101 may transition to the polling for the next communication apparatus 11.

When the information on the state change is included (Yes in S304), the controller 101 performs comparison on the count value included in the response signal, the information on the time at which the polling has been performed, the count value associated with the other information on the state change having already been stored in the storage device 102, and the information on the time at which the polling has been performed, the information on the time being associated with the other information on the state change having already been stored in the storage device 102. In this way, the controller 101 determines the time sequence of the state change indicated by the information on the state change included in the response signal and the state change indicate by the other information on the state change (S305). Based on the determined time sequence, the controller 101 causes the information on the state change included in the response signal to be stored in the storage device 102 (S306). After the processing has proceeded to S306, the controller 101 may transition to the polling for the next communication apparatus 11.

From the above description, the monitoring apparatus 10, which receives from the communication apparatuses 11 the response signals including the information indicative of the differences in time between the occurrences of the state changes and the polling, may determine the time sequence of the occurrences of the information on the state change received from each of the communication apparatuses 11. Thus, the monitoring apparatus 10 may improve the reliability of the time sequence of the occurrences of the information from the communication apparatuses 11 to be monitored collected by the polling and provide such time sequence to the administrator through the administrator terminal 12.

The monitoring apparatus 10 according to the embodiment determines the time sequence of the occurrences of the state changes based on the differences in timing at which the polling is performed on each of the communication apparatuses 11 and the count values included in the response signals. Thus, the clock of the monitoring apparatus 10 and the clock of each of the communication apparatuses 11 are not necessarily in synchronization with one another.

Although it is assumed that the operating frequency is uniform throughout the clock generator 113 of each of the communication apparatuses 11, the operating frequency of the clock generator 113 of each of the communication apparatuses 11 may be nonuniform. In this case, the communication apparatuses 11 may include information indicative of the clock frequency thereof in the response signals. In this way, the monitoring apparatus 10 may determine the time sequence of the state changes even when the clock frequency of each of the communication apparatuses 11 is nonuniform.

### First Variation

Next, a first variation of the above-described embodiment will be described. In the description of the first variation, the same elements as those of the embodiment are denoted by the same reference signs, thereby omitting the description thereof. Although an example in which the communication apparatus 11 detects a single type of the state changes is described according to the above-described embodiment, this is not limiting. The communication apparatus 11 according to the first variation has a flag and a counter for each of the types of the state changes so as to simultaneously detect a plurality of types of the state changes and count the crock for each of the types.

Upon detecting, for example, the state change associated with the LOL, the controller 111 of the communication apparatus 11 sets the state change flag associated with the LOL and starts counting clock cycles associated with the LOL. Next, upon detecting, for example, the state change associated with the LOS, the controller 111 sets the state change flag associated with the LOS and starts counting crock cycles associated with the LOS.

Upon receiving the polling signal from the monitoring apparatus 10, the controller 111 determines the count value of the clock cycles associated with the LOL and the count value of the clock cycles associated with the LOS for which the state change flags have been set. The controller 111 generates the response signal including the information on the state change associated with the LOL, the count value associated with the LOL, the information on the state change associated with the LOS, and the count value associated with the LOS and transmits the generated response signal to the monitoring apparatus 10.

The controller 101 of the monitoring apparatus 10 performs processing for determining the time sequence of the occurrences of the information on the state change associated with the LOL and the information on the state change associated with the LOS included in the response signal based on the count values respectively associated with the LOL and the LOS.

According to the first variation, the monitoring apparatus 10 may determine not only the time sequence of the pieces of the information on the state change received from the plurality of the communication apparatuses 11 but also the time sequence of the plurality of pieces of the information on the state change received from the same communication apparatus 11.

### Second Variation

Next, a second variation of the above-described embodiment will be described. In the description of the second variation, the same elements as those of the embodiment are denoted by the same reference signs, thereby omitting the description thereof. The monitoring apparatus 10 according to the second variation adds time-of-day information to the information on the state change included in the received response signal based on time-of-day information thereof.

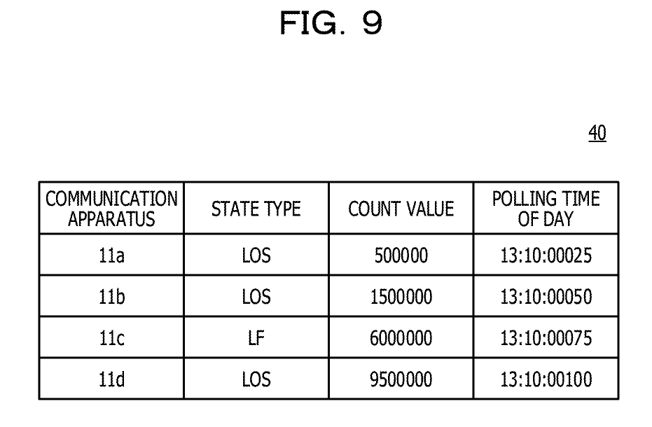

FIG. 9 illustrates an example of a response data table. Upon receiving the response signal from the communication apparatus 11, the controller 101 of the monitoring apparatus 10 associates the information on the state change and the count value included in the response signal with the time of day at which the polling has been performed and stores the information on the state change and the count value in a response data table 40. For example, data of the polling time of day of a record corresponding to the communication apparatus 11a in the response data table 40 indicates thirteen ten and 00.025 seconds.

For example, the controller 101 refers to the response data table 40 and extracts the count value of 500000 and the polling time of day 13:10:00025 for the communication apparatus 11a. The controller 101 determines the time of day at which the state change has occurred in the communication apparatus 11a based on the extracted count value and the polling time of day. For example, based on the count value of 500000, the controller 101 obtains a calculation result that the time of day at which the state change has occurred 13:10:00020 which is 5 msec earlier than the polling time of day 13:10:00025.

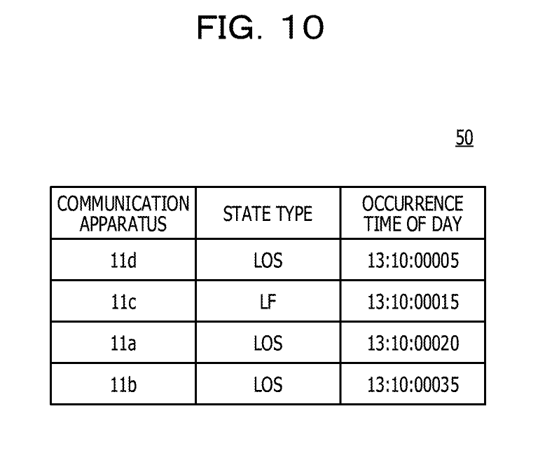

FIG. 10 illustrates an example of an occurrence sequence table. Based on the calculated times of day at which the state changes have occurred, the controller 101 determines the time sequence of pieces of the information on the state change. The controller 101 associates the pieces of the information on the state change and the occurrence times of day with one another based on the determined time sequence and stores the pieces of the information on the state change and the occurrence times of day in an occurrence sequence table 50.

According to the second variation, the monitoring apparatus 10 may determine not only the time sequence of the pieces of the information on the state change received from the plurality of the communication apparatuses 11 but also the times of day at which the state change has occurred in each of the communication apparatuses 11 for the respective pieces of the state change information. The monitoring apparatus 10 may provide the times of day at which the state change has occurred in each of the communication apparatuses 11 to the administrator through the administrator terminal 12. According to the second variation, since the monitoring apparatus 10 uses the time-of-day information thereof, the time-of-day information of the monitoring apparatus 10 and time-of-day information of each of the communication apparatuses 11 are not necessarily synchronized with one another.

In the example according to the embodiment or the variations, the monitoring apparatus 10 and the communication apparatuses 11 which are external apparatuses are described. However, this is not limiting. Alternatively, the respective apparatuses may be considered to be replaced with, for example, packages in a single apparatus or functional blocks in a single package.

The embodiment, variations, and procedures having been described are not limiting. Appropriate changes in processing methods, combinations and the like are possible without departing from the gist of the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method of monitoring comprising:
transmitting, by a computer, a polling signal to a first communication apparatus;
receiving, from the first communication apparatus, information on a first notification target which is detected in the first communication apparatus and first interval information indicative of a difference between timing at which the first notification item is detected and timing at which the polling signal is received in the first communication apparatus; and
determining, based on first time information indicative of timing at which polling is performed and the first interval information, a time sequence of the first notification target and a second notification target which is detected in a second communication apparatus.

2. The method according to claim 1,
wherein the information on the first notification target indicates a state change which is detected in the first communication apparatus.

3. The method according to claim 1,
wherein the determining the time sequence is performed based on second interval information which is received from the second communication apparatus and second time information indicative of timing at which polling associated with information on the second notification target is performed.

4. The method according to claim 1,
wherein the first interval information is determined based on a count of a clock signal between the timing at which the first notification target is detected and the timing at which the polling signal is received.

5. The method according to claim 1,
wherein the process further includes:
associating time-of-day information that indicates a time of day with the information on the first notification target based on the first time information indicative of the timing at which the polling is performed and the first interval information.

6. The method according to claim 1,
wherein the process further includes:
outputting, upon receiving a viewing request, historical information that includes the information on the first notification target and information on the second notification target in a form that allows the time sequence of the first notification target and the second notification target to be understood.

7. The method according to claim 1,
wherein time-of-day information of the computer and time-of-day information of the first communication apparatus are not synchronized with each other, and
a clock signal of the computer and a clock signal of the first communication apparatus are not synchronized with each other.

8. The method according to claim 1,
wherein timing at which the polling signal for the first communication apparatus is transmitted and timing at which a polling signal for the second communication apparatus is transmitted are different from each other.

9. An information processing apparatus comprising:
a memory; and
a processor coupled to the memory and configured to:
transmit a polling signal to a first communication apparatus;
receive, from the first communication apparatus, information on a first notification target which is detected in the first communication apparatus and first interval information indicative of a difference between timing at which the first notification item is detected and timing at which the polling signal is received in the first communication apparatus; and
determine, based on first time information indicative of timing at which polling is performed and the first interval information, a time sequence of the first notification target and a second notification target which is detected in a second communication apparatus.

10. The information processing apparatus according to claim 9,
wherein the information on the first notification target indicates a state change which is detected in the first communication apparatus.

11. The information processing apparatus according to claim 9,
wherein a determination of the time sequence is performed, by the processor, based on second interval information which is received from the second communication apparatus and second time information indicative of timing at which polling associated with information on the second notification target is performed.

12. The information processing apparatus according to claim 9,
wherein the first interval information is determined based on a count of a clock signal between the timing at which the first notification target is detected and the timing at which the polling signal is received.

13. The information processing apparatus according to claim 9,
wherein the processor is configured to associate time-of-day information that indicates a time of day with the information on the first notification target based on the first time information indicative of the timing at which the polling is performed and the first interval information.

14. The information processing apparatus according to claim 9,
wherein the processor is configured to output, upon receiving a viewing request, historical information that includes the information on the first notification target and information on the second notification target in a form that allows the time sequence of the first notification target and the second notification target to be understood.

15. The information processing apparatus according to claim 9,
wherein time-of-day information of the information processing apparatus and time-of-day information of the first communication apparatus are not synchronized with each other, and
a clock signal of the information processing apparatus and a clock signal of the first communication apparatus are not synchronized with each other.

16. The information processing apparatus according to claim 9,
wherein timing at which the polling signal for the first communication apparatus is transmitted and timing at which a polling signal for the second communication apparatus is transmitted are different from each other.

17. A communication apparatus comprising:
a memory; and
a processor coupled to the memory and configured to:
receive a polling signal from a transmission apparatus which collects a notification target;
calculate a difference between timing at which the notification target is detected and timing at which the polling signal is received;
generate a response signal including interval information indicative of the difference and information on the notification target; and
transmit the response signal to the transmission apparatus.
